(19) United States
(12) Patent Application Publication
(10) Pub. No.: US 2017/0364976 A1
(43) Pub. Date: Dec. 21, 2017

(54) COMPUTER SYSTEM INTEGRATING A WHOLESALE DISTRIBUTION NETWORK INTO AN EXISTING SUPPLY CHAIN

(71) Applicant: IMARKET, LLC., Mason, TX (US)

(72) Inventors: John William Watson, Mason, TX (US); Brian Thomas Long, Cedar Park, TX (US)

(21) Appl. No.: 15/187,683

(22) Filed: Jun. 20, 2016

(51) Int. Cl. G06Q 30/06; G06Q 10/08

(52) U.S. Cl. CPC G06Q 30/0601; G06Q 10/083; G06Q 10/087

(57) ABSTRACT

A computer system having a network of computers configured to assist in order fulfillment and retail sales is disclosed. In one embodiment, consumer application devices with location awareness interact with an Internet based server side (e.g., Portal, Cloud Server, etc.) to identify product offerings available based on location of the consumer application device (Proximity Based Offerings). Consumers may query offerings from Food Service Operators (FSOs) or other merchants and request purchase capabilities for offerings made available through the FSO/merchant existing supply chain. FSOs/merchants may control proximity parameters for product offerings. FSOs may allow multiple services for their customers rather than being only a provider of prepared meals.

### TECHNICAL FIELD OF THE INVENTION

The present disclosure relates generally to a computer system network configured to utilize an existing wholesale distribution network and existing customer supply chain. More particularly, this disclosure relates to an application executing across multiple computer based devices that allows consumers, wholesalers and retailers to recognize benefits of existing infrastructure in an optimized manner to provide benefits to each layer of an existing supply chain.

### BACKGROUND

Historically, food distribution to a consumer has been done in several different ways. Food in an unprepared state (e.g., raw materials) has typically been purchased by the consumer at a grocery store or at a “wholesale warehouse” such as Costco or Sam's Club. In this model, the consumer travels to the point of sale and walks the aisles to collect desired items from shelves in the store. This model provides customers with items at retail (or substantially close to retail) prices. While the wholesale warehouse provides a customer with slightly discounted prices those prices are still above true wholesale. Further, the wholesale warehouse model sometimes forces a consumer to purchase large quantities of a particular item to recognize any savings.

Food in a semi-prepared state has more recently been made available in the form of “ready to prepare” meals provided by companies like Blue Apron or the like. The concept behind the “ready to prepare” meals is that all ingredients, seasonings, and preparation instructions are provided in exactly the right proportions to make a meal. Similarly, uncooked but prepared meals may be purchased as “ready to cook” or frozen food where the consumer simply cooks the prepared meals for a period of time prior to consumption. Each of these models of ready to cook or ready to prepare do not provide customers with discounted pricing and in fact increase the price because the provider has performed an additional service to get the food to the customer according to the model.

As an alternative to grocery shopping, some people simply go to a restaurant or other type of food service operator (FSO) to eat a fully prepared meal. In contrast to grocery shopping, an FSO interacts with a food service distributor (FSD) to receive its raw materials to be utilized in preparing meals on-site. An FSD functions as an intermediary between food manufacturers and one or more FSOs. The FSD purchases, stores, sells, and delivers products, providing FSOs with access to items from a wide variety of manufactures. FSDs procure pallets and bulk inventory quantities that are broken down to case and sometimes unit quantities for the FSO. FSOs may purchase from a range of local, specialty, and broad line FSDs on a periodic basis (e.g., daily, weekly, etc.). This model of distribution allows the FSO to recognize convenience and significant savings based in part on the fact that the FSD procures in bulk from the manufacturer and passes some of that savings onto the FSO.

Based on the current state of the art, household consumers obtain no individual direct benefit from an FSD. Accordingly, disclosed herein are systems and methods to address this and other problems and provide further benefits to at least individual consumers, FSOs, and FSDs.

### BRIEF DESCRIPTION OF THE DRAWINGS

The following figures form part of the present specification and are included to further demonstrate certain aspects of the present claimed subject matter, and should not be used to limit or define the present claimed subject matter. The present claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings. Additionally, like reference numerals in the drawings identify identical or substantially similar elements, wherein:

FIG. 1 illustrates a computing device in view 100 that contains a non-exhaustive collection of components and capabilities for computer devices that may be utilized in accordance with some embodiments of the present disclosure;

FIG. 2 illustrates a functional flow 200 describing a possible customer (e.g., consumer) interaction with one or more computer systems and providers in accordance with some embodiments of the present disclosure;

FIG. 3 illustrates a functional flow 300 describing a possible food service operator (FSO) interaction with one or more computer systems and consumers/providers/employees in accordance with some embodiments of the present disclosure;

FIG. 4 illustrates a functional flow 400 describing another possible interaction of a consumer with one or more computer systems in accordance with some embodiments of the present disclosure;

FIG. 5 illustrates a functional flow 500 outlining possible interactions that may take place with an Internet hosted service (e.g., cloud based portal) in accordance with some embodiments of the present disclosure;

FIG. 6 illustrates a functional flow 600 outlining a product search and inquiry feature relating to allowing a customer to obtain information about a product they desire that may not have been previously made available by an FSO in accordance with some embodiments of the present disclosure; and

FIG. 7 illustrates a network diagram 700 showing possible interactions between consumers and providers as well as different computing devices in accordance with some embodiments of the present disclosure.

### NOTATION AND NOMENCLATURE

Certain terms are used throughout the following description and claims to refer to particular components, configurations of components, and functions provided by people/service providers/computers/networks. As one skilled in the art will appreciate, the same component may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . .”

Food Service Operator (FSO): a type of merchant that is used herein to describe a commercial entity that receives product from a Food Service Distributor (FSD) and provides products (in the same form or a different form) to a consumer. One example of an FSO as described herein is a dine-in restaurant. Other examples could include, hospitals, convenience stores, and others that will become apparent as described below.

Food Service Distributor (FSD) is used herein to describe an entity that coordinates conveyance of a product between a manufacturer and an FSO. Examples of an FSD in accordance with this disclosure are Sysco, US Foods, and Performance Food Group (PFG).

Consumer or Customer as used herein each refer to an end-user of the disclosed computer application that may purchase food in the raw state from an FSO presumably to eliminate the need to visit a grocery store to obtain that same product. These terms typically refer to a non-corporate identity at one end of the supply chain and not an intermediate entity in the supply chain.

Proximity Perimeter as used herein refers to a defined geographical proximity of an application user relative to a known geographical point which may be location of one or more FSOs providing a service as disclosed herein or a “landmark” for use in determining where offerings are applicable (See PBC). The Proximity Perimeter may be set to infinite such that the setting is effectively turned off, may be set to within restaurant perimeter such that a consumer needs to basically be at the FSO, or may be set to anything in-between. For example, a 5-mile radius of the FSO may be a setting. Additionally, the Proximity Perimeter may be relative to a landmark other than the actual FSO such that an FSO may provide offerings to people of different regions. In this case an FSO may provide different offerings to customers that are currently located in different geographical locations or regions.

Proximity Based Coupon (PBC) as used herein refers to an offering that is made available to people based on that person's current location. Note that customers in different locations may concurrently receive different offerings for the same (or different) products based on this concept. An FSO may concurrently provide a special on Chicken in one town and a special on Ribs in another. This may be used to drive interest in traveling to the FSO to obtain dine-in service in conjunction with receiving product in the raw state for example. In a similar manner, people further away from the FSO may receive offers indicating additional savings (relative to those near the FSO) to entice them to travel to the FSO.

Proximity Based Notification (PBN) as used herein refers to a notification sent to a customer's application device based on a determined geographical location of that application device. In one example, a PBN may be sent to customers within an FSO (e.g., currently eating a dine-in meal) at that FSO. In another example, a PBN may be sent to customers within a proximity of a competitor to entice that customer to not shop at the competitor because of offerings made available at the establishment defining the PBN. In this example, direct marketing may be taken to the level of marketing to consumers that are about to shop at a competitor based on a temporal and geographical determination relating to the location of that consumer.

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. The same or similar parts may be marked with the same or similar reference numerals.

While various embodiments are described herein, it should be appreciated that the present disclosure encompasses many inventive concepts that may be embodied in a wide variety of contexts. The following detailed description of example embodiments, read in conjunction with the accompanying drawings, is merely illustrative and is not to be taken as limiting the scope of the invention, as it would be impossible or impractical to include all of the possible embodiments and contexts of the invention in this disclosure. Upon reading this disclosure, many alternative embodiments of the present invention will be apparent to persons of ordinary skill in the art. For example, the supply chain outlined herein may not conform exactly to all existing supply chains but will have comparable components that are easily understood to be interchangeable based on function.

The scope of the invention is defined by the appended claims and equivalents thereof. Illustrative embodiments of the invention are described below. In the interest of clarity, not all features of an actual implementation are described in every embodiment disclosed in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. As understood by those skilled in the art, elements in flow charts may be performed in the order shown or may be performed in an order different than shown to achieve the same or a similar result.

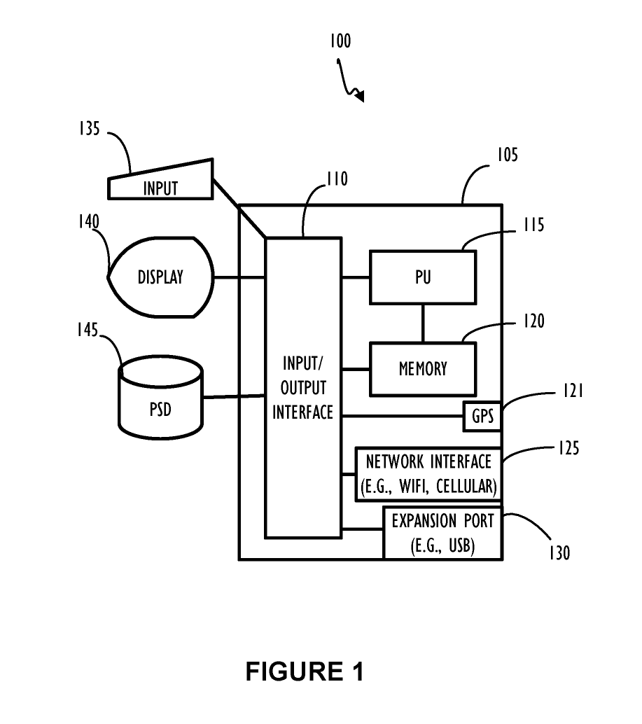

Referring now to FIG. 1, example computing device 100 is shown. One or more example computing devices 100 may be included in a tablet, cellular phone, laptop, mainframe or other type of distributed computer (none of which are explicitly shown). Example computing device 100 comprises a programmable control device 105 that may be optionally connected to input devices 135 (e.g., keyboard, mouse, touch screen, etc.), display 140 and/or program storage device (PSD) 145 (sometimes referred to as a direct access storage device DASD, random access memory RAM, or solid state “flash” storage memory). Also, included with program control device 105 is network interface 125 for communication via a network (e.g., TCPIP, Cellular, Bluetooth, etc.) with other computing and corporate infrastructure devices (not shown). Note network interface 125 may be included within programmable control device 105 or be external to programmable control device 105. In either case, programmable control device 105 will be communicatively coupled to network interface 125. Also note, program storage device 145 represents any form of non-volatile storage including, but not limited to, all forms of optical and magnetic storage elements including solid-state storage. Expansion port 130 may be included with or interfaced to program control device 105 and allow for attachment of additional components (not shown). Global Positioning System (GPS) 121 may be interfaced to programmable control device 105 to allow for location services or device tracking and allow for such features as proximity based options.

Program control device 105 may be included in a computing device and be programmed to perform methods in accordance with this disclosure. Program control device 105 may itself comprise processor unit (PU) 115, input-output (I/O) interface 110 and memory 120. Processing unit 115 may include any programmable control device including, for example, processors of an IBM mainframe (such as a quad-core z10 mainframe microprocessor). Alternatively, in non-mainframe systems examples of processing unit 115 include the Apple processors from Apple Computer Corporation, Intel Core®, Pentium® and Celeron® processor families from Intel and the Cortex and ARM processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 120 may include one or more memory modules and comprise random access memory (RAM), read only memory (ROM), programmable read only memory (PROM), programmable read-write memory, and solid state memory. One of ordinary skill in the art will also recognize that PU 115 may also include some internal memory including, for example, cache memory. Also, one of ordinary skill in the art will recognize that virtual implementations of the above hardware are also possible on other physical hardware configured to emulate the actions of physical hardware consistent with program control device 105. Virtual implementations are often found in Cloud based systems hosted on the Internet.

Aspects of the embodiments are described as a method of control or manipulation of data, and may be implemented in one or a combination of hardware, firmware, and software. Embodiments may also be implemented as instructions stored on a machine-readable medium, which may be read and executed by at least one processor to perform the operations described herein. A machine-readable medium may include any mechanism for tangibly embodying information in a form readable by a machine (e.g., a computer). For example, a machine-readable medium (sometimes referred to as a program storage device or a computer readable medium) may include read-only memory (ROM), random-access memory (RAM), magnetic disc storage media, optical storage media, flash-memory devices, electrical, optical, and others.

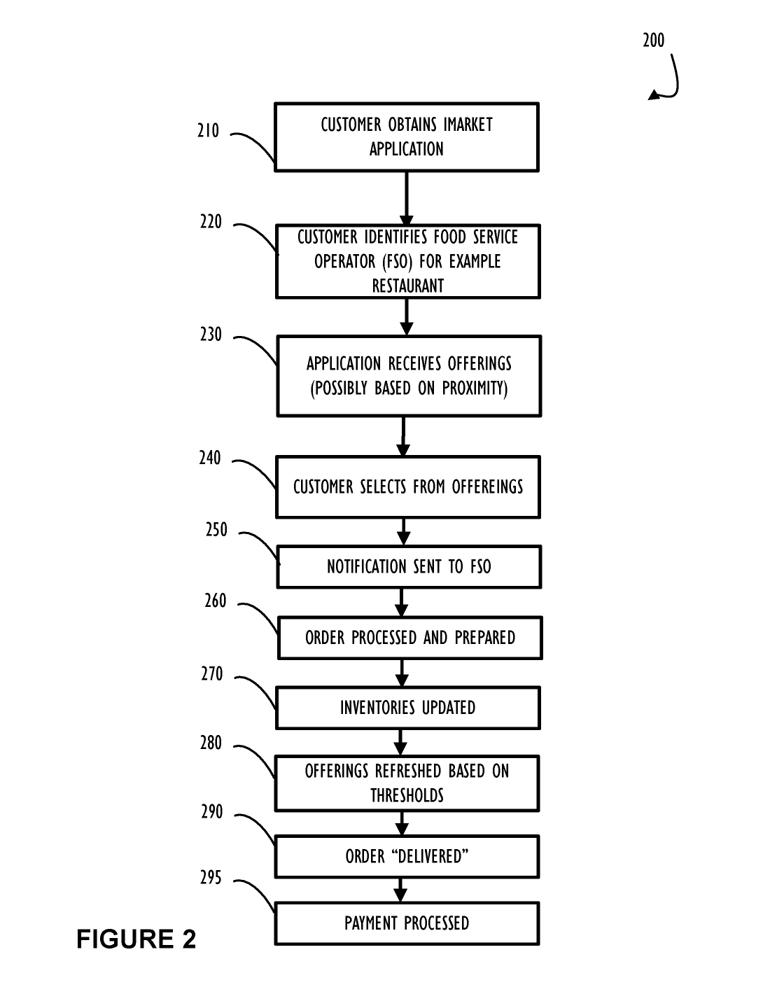

Referring now to FIG. 2, functional flow 200 describes a possible customer interaction with one or more computer systems to perform acts in accordance with this disclosure. In this example embodiment, consider a customer interacting with a cellular phone (e.g., either an iPhone or an Android based device). At block 210, the customer obtains an iMarket computer application that is appropriate for their cellular smart phone. The iMarket computer application (“application”) may be obtained via download from an FSO or from an “application store” such as Apple's appstore or Google's Google play. After downloading and initiating the application a customer may identify a particular FSO (block 220) at which to obtain discounted food products. As used in this example, “discounted food products” refers to food offerings from the identified FSO at a price point between cost to the FSO and standard retail price as would be available at a local grocery store. Alternatively, the customer may receive a savings based on convenience where they save time and travel expenses for example. Further, a customer may be able to obtain a wider variety of selections than would be stocked at a local grocery store. At block 230, the application may receive offerings associated with the identified FSO and these offerings may be further refined based on proximity as will be described in more detail below. At block 240, the customer interacts with the application and selects items for purchase from the available offerings. At block 250, a notification identifying that particular customer and their selections may be sent to the identified FSO. As explained in more detail below, there may be one or more intermediary computing devices facilitating transmittal of the information from the customer phone executing the application and the “receiving” computing device located at the FSO. At block 260, after receipt of the above mentioned notification, information from the notification may be processed to determine how to satisfy the customer's requests and preparation of the customer's order may be initiated. Block 270 illustrates that inventories at the FSO may be either manually or automatically updated to reflect any adjustment necessary based on fulfillment of this customer's order. Block 280 illustrates that offerings provided by the application may be altered (e.g., refreshed) based on pre-determined thresholds as established by the FSO so as to maintain desired inventory. For example, the restaurant may need to keep a certain amount of product on hand to satisfy its dine-in customers rather than selling additional quantities of a particular offering through the application. Accordingly, when an inventory threshold is crossed for a particular item that item may be automatically added/removed from a particular FSO's available offerings. Block 290, illustrates that a customer may arrive at the FSO and have their order “delivered” to them while they are at the restaurant for example. Block 295, illustrates that payments relating to an order may be processed at the FSO.

To further elaborate on the above high-level flow, please consider the following additional information of an example transaction that may take place in accordance with disclosed embodiments. Customer A1 has an Apple iPhone and is visiting “TwoService” restaurant for a dine-in meal. While at TwoService, customer A1 downloads the iMarket application from the appstore. A1 identifies TwoService to the iMarket application and receives offerings of raw-product available to users of the iMarket application that are currently available at TwoService. Because A1 is actually inside a proximity perimeter of the restaurant TwoService, A1 receives access to all offerings for people within that location. A1 orders and presumably enjoys his meal while his order through the iMarket application is concurrently prepared. At the end of the meal, A1 pays for his meal and iMarket order and departs with food in a raw state to take home for later use.

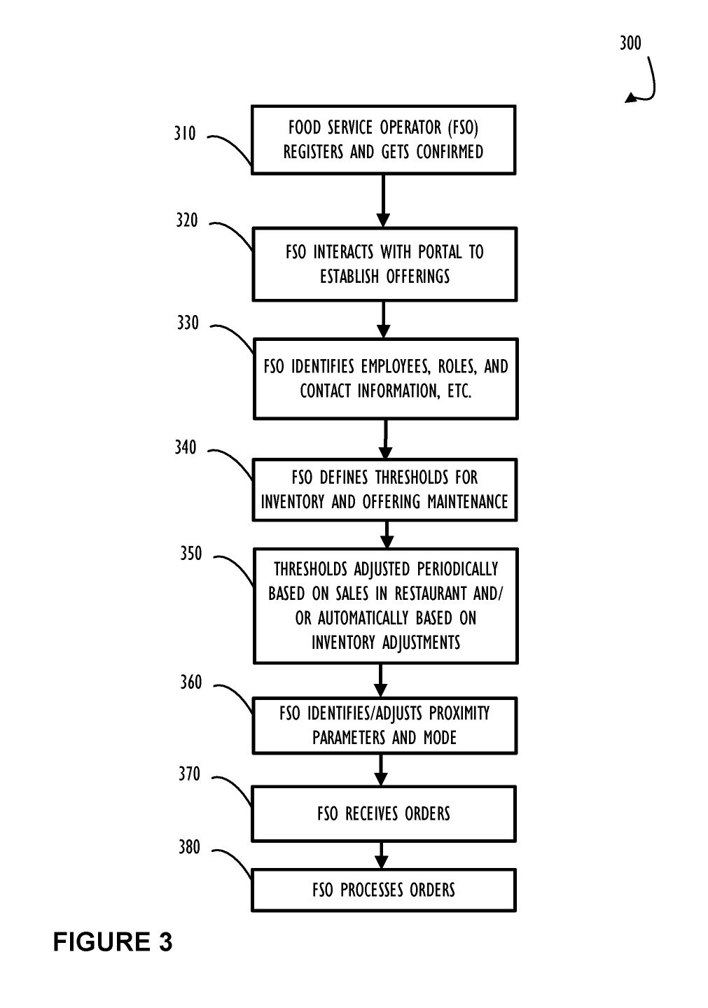

Referring now to FIG. 3, functional flow 300 describes a possible interaction of an FSO (e.g., restaurant owner) and other components/personnel (e.g., web interface to cloud based application servers) to perform methods in accordance with this disclosure. Beginning at block 310, the FSO registers and gets confirmed as a provider of services in accordance with rudiments of the application (i.e., iMarket application). At block 320, the FSO interacts with the portal to establish offerings and optionally defining proximity parameters for the offerings. At block 330, the FSO may define roles of employees to prepare orders received via the iMarket application and define contact information (e.g., cell numbers) such that text messaging and emails may be sent directly to employees with information to fulfil orders. At block 340, the FSO may define thresholds for inventory and order maintenance. For example, to maintain sufficient quantities of product for dine-in customers. Block 350 illustrates that thresholds may be adjusted periodically based on sales in the restaurant and may be automatically adjusted based on inventory adjustments such as receipt of additional supplies from an FSD. Block 360 illustrates that an FSO may adjust proximity parameters and may adjust operational mode to turn on or off proximity parameter rules at a global level. Block 370 illustrates that FSO receives orders (i.e., notifications of customer orders) from an iMarket application server for example. Block 380 illustrates that the FSO may process the orders to prepare them for customer pickup. Order processing may include sending text messages to employees of the FSO based on their roles such that they are aware of how to fulfil any pending orders. In this manner, multiple employees may concurrently process different aspects of a received notification/order.

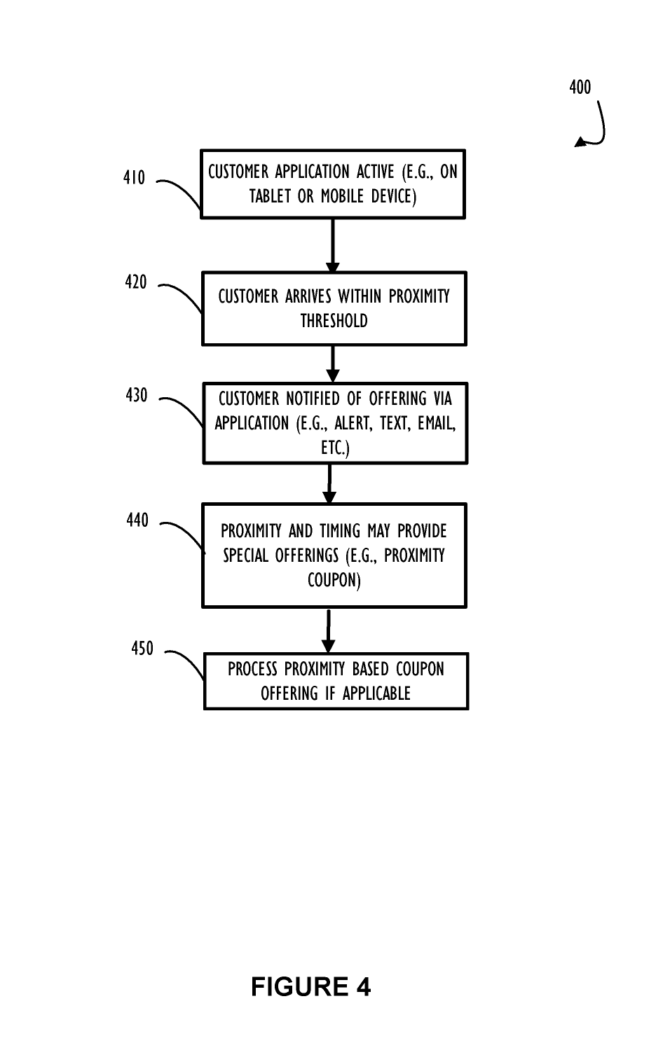

Referring now to FIG. 4, functional flow 400 describes additional potential interactions between a customer utilizing the iMarket application and one or more computer systems in accordance with disclosed embodiments. Beginning at block 410, a customer has the application (e.g., iMarket consumer application) active on a phone, tablet or other mobile device. Note, that the application may also be utilized at a stationary computer such as a home desktop computer but will be described in this example as a mobile device. At block 420, the customer arrives within the proximity threshold of an FSO registered with iMarket and having active iMarket offerings. Block 430 illustrates that the application on the customer's device notifies the customer of the offering. This notification may be either active or passive. An active notification may include an email, text message, or instant message (for example) being sent to the customer's device. A passive notification refers to an offering being shown in the context of the iMarket consumer application based on a user simply interacting with the application. Block 440 illustrates that proximity and timing may affect what offerings are available to that customer. For example, via a proximity based coupon (PBC) or based on which FSOs are available to the customer based on each individual FSOs proximity parameters. Block 450 illustrates that a customer may acknowledge that they want to obtain a particular offering and initiate a notification to the FSO. Note that because the customer's device knows its own proximity and can communicate this in the notification to the FSO, the FSO may be confident that the customer satisfies the criteria of the proximity based offering (including a PBC if applicable).

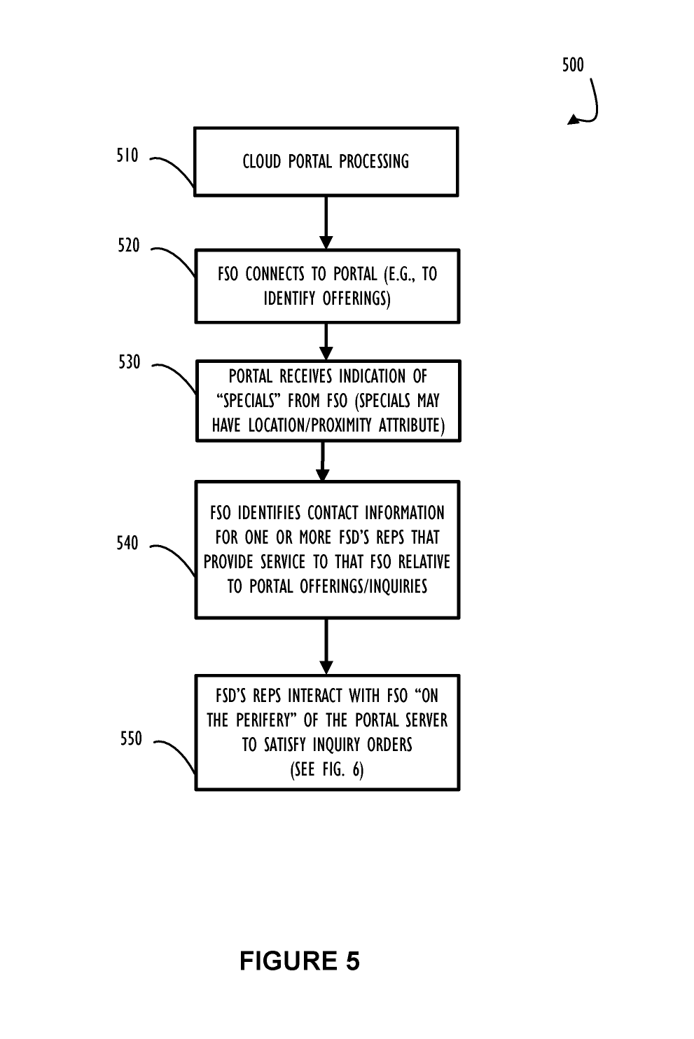

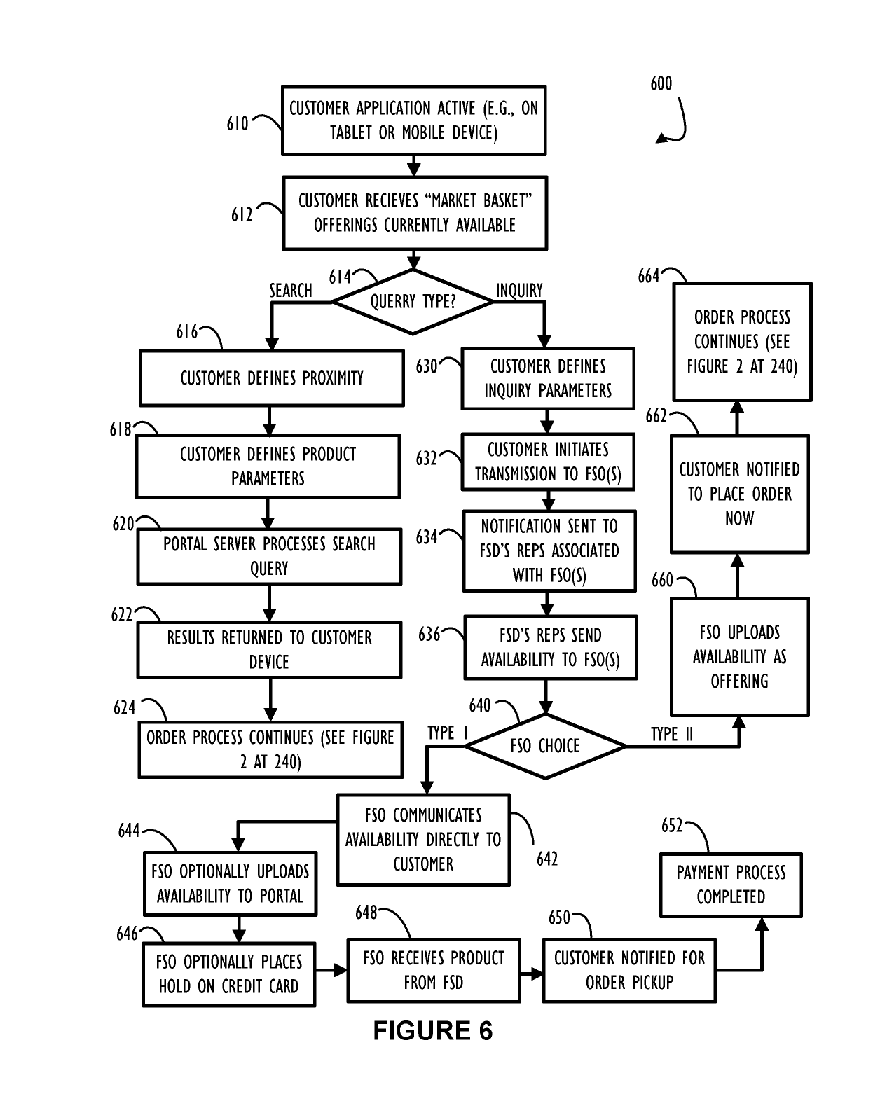

Referring now to FIG. 5, functional flow 500 outlines some possible interactions that may take place with an Internet hosted service (e.g., cloud based server running the server side of the iMarket application) in accordance with some disclosed embodiments. Beginning at block 510, a cloud based application is available for interaction with FSOs and customers. Block 520 illustrates that an FSO may interact with the portal (interface to server side hosted on Internet server, cloud based server, etc.) to identify available offerings. Block 530 illustrates the FSO may identify offerings currently available to potential customers. Offerings “uploaded” by an FSO may also have a location/proximity based attribute to define their availability as discussed herein. Block 540 illustrates other interactions between the FSO and the portal interface. For example, the FSO may identify contact information for one or more representatives that provide service offerings from an FSD. These contact attributes may be used to facilitate ordering capabilities different from a standard offering, for example, as discussed with respect to FIG. 6 below. Block 550 illustrates possible interactions between the server side iMarket application and representatives of one or more FSDs. For example, in the embodiments of FIG. 6, FSD representatives can receive information from customers and FSOs “on the periphery” of the disclosed portal application. Internet based communications such as email, or text based communications such as twitter and texting (SMS) may be initiated within the context of the portal application and follow up communications may take place using direct emails, texting, etc. between the FSD representative(s) and FSO representative(s) as necessary to complete an order initiated by the customer (see Inquiry order discussed with FIG. 6).

Referring now to FIG. 6, flow diagram 600 outlines a possible product search and inquiry feature relating to allowing a customer to obtain information about a product they desire that may not have been previously made available by an FSO in accordance with some embodiments of the present disclosure. Beginning at block 610, a customer has the client side portion of the disclosed system available on a computer system (e.g., desktop or mobile device such as laptop, tablet, or phone). At block 612, the customer obtains access to “Market Basket” offerings that represent the offerings currently available (previously made available by FSO). Decision 614 indicates that the customer may make at least two types of queries of the server side portion of the disclosed system. If a “SEARCH” type query, then flow continues to block 616. If an “INQUIRY” type query, then flow continues to block 630. Block 616 indicates the customer may define a proximity in which to search for an offering (e.g., 5-mile radius, 10-mile radius, town name, address, zip code, etc.). Block 618 indicates the customer may define product parameters to indicate what they are interested in purchasing. Block 620 indicates that the search parameters are communicated to the server side system and the query may be processed for a matching offering. Block 622 indicates that results of the request are communicated back to the client device. As shown at block 624, if a matching offering is found, the customer may continue to indicate a desire to purchase the offering as described in flow 200, element 240 of FIG. 2 (described above).

If an “INQUIRY” type query was identified at decision 614, flow continues to block 630 which indicates a customer may define inquiry parameters. The inquiry parameters may identify any or all of: an item, a quantity of that item, a desired/expected price for that quantity. Block 632 indicates that the customer may initiate transmission to a selected set of FSOs. Of course, in line with the rest of this disclosure, the selected set could be based on manual selection or a defined proximity among other means of identification of FSOs. Block 634 indicates that a notification may then be automatically relayed using the identified FSO's association with FSD representatives to determine a way to fulfill the request. This automatic relay may take place on the server side of the application without any involvement of any particular FSO or an FSO may desire to acknowledge the request prior to it being automatically forwarded by the server side. Recall, the server side portion of the computer system may have contact information for FSD representatives as outlined above with respect to FIG. 5. Block 636 indicates that after receiving the above outlined request for product, one or more of the FSD's representatives may send availability to FSO's that may meet the requirements of the request for product. Decision 640 indicates that an FSO has at least two options to relay received availability information to a customer. If “TYPE I” flow continues to block 642 which indicates the FSO may contact the customer directly. After communicating with the customer, the FSO may upload the product availability into the server side (e.g., via web Portal interface) as shown at block 644. Flow continues to block 646 where the FSO may optionally place a “hold” on the customer's credit card as a means to secure final fulfillment of the order prior to obtaining the product from the FSD. Block 648 indicates the FSO receives the requested product from the FSD and then the customer is notified for pickup as shown at block 650. As a final step of the TYPE I processing, block 652 indicates that the customer picks up the order and completes the payment process with the FSO.

Alternatively, the FSO may chose a “TYPE II” flow from decision 640 and flow continues to block 660 which indicates the FSO simply adds the requested products to its standard offering interface. Block 662 indicates the FSO may then notify the customer to place an order through the standard interface for the newly available product and flow continues to block 664 which indicates the order process continues as shown above with respect to FIG. 2 block 240.

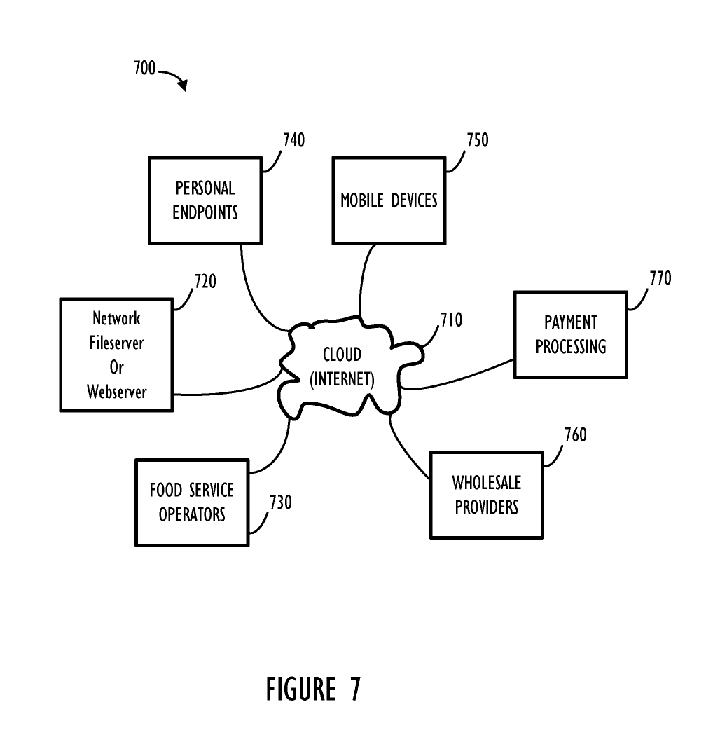

Referring now to FIG. 7, network diagram 700 illustrates possible interactions and network connections between consumers, providers (FSOs, FSDs, etc.), and their associated computer devices in accordance with some disclosed embodiments. Block 710 illustrates a network such as the Internet or network applications as may be hosted for example in the cloud. Block 720 illustrates possible network servers or webservers configured with a server side portion of the iMarket application to facilitate embodiments of this disclosure. Block 730 illustrates computer systems at one or more FSOs and their connection via the network 710 to other computer systems in accordance with disclosed embodiments. Block 740 illustrates personal endpoints such as in-home desk top computers and their connection via network 710 to other computer systems in accordance with disclosed embodiments. Block 750 illustrates mobile devices of customers and/or employees of FSOs and their connection via network 710 (and possibly a cellular network not shown) to other computer systems in accordance with disclosed embodiments. Block 760 illustrates computer systems of whole sale providers (e.g., FSDs) and their connection via network 710 to other computer systems in accordance with disclosed embodiments. Block 770, illustrates that payment processing systems and various service providers for those systems may be connected to facilitate one or more ecommerce type transactions as part of the outlined in the methods disclosed herein.

With the above understanding of the disclosed embodiments, some additional features that may be implemented in one or more embodiments are described here. The server side application may track a variety of metrics regarding order fulfillment for use in future optimization of processes, trouble shooting order issues, or general historical information tracking, as well as other uses. For example, tracking of which employees received messages as part of order fulfillment and which employees actually acknowledged order completion. FSOs may be assisted by the server side by providing auto-populated upload forms based on previous order history. Merchant numbers may be tracked to insure fees for credit cards are applied to appropriate cost centers. Direct marketing campaigns for future offerings may be assisted via the historically maintained information. A customer with a purchase history may receive recommendations when traveling to notify them of restaurants near their current location serving similar items to what the customer has previously purchased.

Another opportunity of the iMarket application not previously available would be additional ways for FSOs to compete for customers of other FSOs. For example, a customer obtains the iMarket application at a particular FSO (restaurant). The customer has visibility to the market basked offerings from that particular restaurant. Because the customer is connected to the iMarket network, FSOs that are also part of the network and have not had this customer can now compete for this customer and entice them to dine-in or shop in their market basket. For example, multiple FSOs within a geographical range can see customers that are within the appropriate proximity and provide them information in an effort to have them utilize their services. This is because the customer sees not only the FSO (restaurant) that they initially set up but multiple restaurants as well as Market Basket offerings as based on the proximity settings of other FSOs and the client device.

In the above detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

Various changes in the details of the illustrated operational methods are possible without departing from the scope of the following claims. For instance, illustrative flow chart steps or process steps of FIGS. 2-5 may be performed in an order different from that disclosed here. Alternatively, some embodiments may combine the activities described herein as being separate steps. Similarly, one or more of the described steps may be omitted, depending upon the specific operational environment the method is being implemented in. In addition, acts in accordance with FIGS. 2-5 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”).

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

What is claimed is:

1. A computer system configured to perform server side actions as part of a distributed, network based, computer application, the computer system comprising one or more processing units, memory communicatively coupled to the one or more processing units, and one or more network interfaces communicatively coupled to the memory and to the one or more processing units, wherein the memory comprises computer instructions to cause the one or more processing units to:
receive product offering information via the one or more network interfaces from one or more food service operators, the product offering information comprising at least a subset of information from one or more food service distributors, wherein the information from the one or more food service distributors comprises information pertaining to availability of wholesale raw food product deliverable to the one or more food service operators via the one or more food service distributors;
obtain operational information relating to a first food service operator of the one or more food service operators, the operational information comprising a geographical location of the first food service operator, a proximity parameter associated with the first food service operator, a notification address for the first food service operator, and operator identification information for the first food service operator;
receive first customer information via the one or more network interfaces from a first client device associated with a first customer, the first customer information comprising a first current geographical location of the first client device and first customer identification information for the first customer;
correlate at least the first current geographical location of the first client device with the proximity parameter associated with the first food service operator to determine first applicable product offering information from the first food service operator to the first customer;
send first results information via the one or more network interfaces toward the first client device, the first results information comprising the first applicable product offering information, the operator identification information, and information pertaining to the geographical location of the first food service operator;
receive a response to the first results information via the one or more network interfaces from the first client device, the response indicating a customer selection; and
send a notification message to the notification address for the first food service operator, the notification message comprising the first customer identification information and the customer selection.

2. The computer system of claim 1, wherein the memory further comprises computer instructions to cause the one or more processing units to:
receive second customer information via the one or more network interfaces from a second client device associated with a second customer, the second customer information comprising a second current geographical location of the second client device and second customer identification information for the second customer;
correlate at least the second current geographical location of the second client device with the proximity parameter associated with the first food service operator to determine second applicable product offering information from the first food service operator to the second customer;
send second results information via the one or more network interfaces toward the second client device, the second results information comprising the second applicable product offering information, the operator identification information, and information pertaining to the geographical location of the first food service operator;
wherein the second results information is different than the first results information based at least in part on a relative difference in geographical proximity to the first food service operator of the second client device and the first client device.

3. The computer system of claim 2, wherein the first results information and the second results information are different in price for at least one common applicable offering in the first applicable product offering information and the second applicable product offering information, wherein the price for the at least one common applicable offering is less for whichever of the first client device and second client device is further away from the first food service operator.

4. The computer system of claim 1, wherein the notification message comprises a message type selected from the group consisting of a text message, an email, a tweet, an instant messaging message, or an Internet message.

5. The computer system of claim 1,
wherein the operational information further comprises individual contact information for one or more employees of the first food service operator and order fulfillment responsibilities for the one or more employees; and
wherein the instructions to cause the one or more processing units to send a notification message further comprise instructions to cause the one or more processing units to send a plurality of messages using the individual contact information, the plurality of messages configured to partition information about the customer selection based at least in part on the order fulfillment responsibilities.

6. The computer system of claim 5, wherein the plurality of messages comprise a message type selected from the group consisting of a text message, an email, a tweet, an instant messaging message, or an Internet message.

7. The computer system of claim 1, wherein the instructions to cause the one or more processing units to correlate at least the first current geographical location of the first client device with the proximity parameter associated with the first food service operator to determine first applicable product offering information from the first food service operator to the first customer further comprise instructions to prevent at least one possible applicable product offering from being sent to the first client device based on the first client device being further than a threshold distance from the first food service operator.

8. The computer system of claim 7, wherein the threshold distance is selected from the group consisting of: a distance within 100 yards, a distance within 1 mile, a distance within 5 miles, and a distance within 25 miles.

9. The computer system of claim 1, wherein the instructions to cause the one or more processing units to send first results information further comprise instructions to cause the one or more processing units to send an alert to the first client device.

10. The computer system of claim 9, wherein the instructions to cause the one or more processing units to send an alert to the first client device further comprise instructions to cause the one or more processing units to send the alert based on a change in threshold proximity of the first client device and the geographical location of the first food service operator.

11. The computer system of claim 10, wherein the instructions to cause the one or more processing units to send the alert based on the change in threshold proximity further comprise instructions to cause the one or more processing units to automatically initiate the alert regardless of client side application activity on the first client device.

12. The computer system of claim 1, wherein the memory further comprises instructions to cause the one or more processing units to maintain information identifying historical activity associated with the first client device.

13. The computer system of claim 12, wherein the memory further comprises instructions to cause the one or more processing units to utilize the maintained historical information to determine the first applicable product offering information prior to sending the first results information.

14. The computer system of claim 1, wherein the memory further comprises instructions to cause the one or more processing units to maintain information identifying historical activity associated with order fulfillment associated with the first client device.

15. The computer system of claim 14, wherein the information identifying historical activity associated with order fulfillment comprises information about the first food service operator and employees associated with the first food service operator relating to activities performed by individuals to service each order.

16. The computer system of claim 1, wherein the operational information further comprises contact information for one or more food service distributor representatives and the memory further comprises computer instructions to cause the one or more processing units to receive the response comprise instructions to cause the one or more processing units to:
identify the customer selection as not matching the first applicable product offering information; and
initiate transmission of a food service distributor notification to one or more food service distributor representatives associated with the first food service operator, the food service distributor notification describing a customer product inquiry for product not already available.

17. A computer system configured to perform server side actions as part of a distributed, network based, computer application, the computer system comprising one or more hardware based processing units, hardware based memory communicatively coupled to the one or more hardware based processing units, and one or more hardware based network interfaces communicatively coupled to the hardware based memory and to the one or more hardware based processing units, wherein the hardware based memory comprises computer instructions to cause the one or more hardware based processing units to emulate at least one other virtualized computer system, the virtualized computer system configured with virtualized processing units, virtualized memory, and network access interfaces, wherein the virtualized processing units are configured to:
receive product offering information via the network access interfaces from one or more food service operators, the product offering information comprising at least a subset of information from one or more food service distributors, wherein the information from the one or more food service distributors comprises information pertaining to availability of wholesale raw food product deliverable to the one or more food service operators via the one or more food service distributors;
obtain operational information relating to a first food service operator of the one or more food service operators, the operational information comprising a geographical location of the first food service operator, a proximity parameter associated with the first food service operator, a notification address for the first food service operator, and operator identification information for the first food service operator;
receive first customer information via the network access interfaces from a first client device associated with a first customer, the first customer information comprising a first current geographical location of the first client device and first customer identification information for the first customer;
correlate at least the first current geographical location of the first client device with the proximity parameter associated with the first food service operator to determine first applicable product offering information from the first food service operator to the first customer;
send first results information via the network access interfaces toward the first client device, the first results information comprising the first applicable product offering information, the operator identification information, and information pertaining to the geographical location of the first food service operator;
receive a response to the first results information via the network access interfaces from the first client device, the response indicating a customer selection; and
send a notification message to the notification address for the first food service operator, the notification message comprising the first customer identification information and the customer selection.

18. The computer system of claim 17, wherein the operational information further comprises contact information for one or more food service distributor representatives and the virtualized processing units are configured to receive the response are further configured to:
identify the customer selection as not matching the first applicable product offering information; and
initiate transmission of a food service distributor notification to one or more food service distributor representatives associated with the first food service operator, the food service distributor notification describing a customer product inquiry for product not already available.

19. The computer system of claim 17, wherein the information identifying historical activity associated with order fulfillment comprises information about the first food service operator and employees associated with the first food service operator relating to activities performed by individuals to service each order.

20. The computer system of claim 17,
wherein the operational information further comprises individual contact information for one or more employees of the first food service operator and order fulfillment responsibilities for the one or more employees; and
wherein the instructions to cause the one or more processing units to send a notification message further comprise instructions to cause the one or more processing units to send a plurality of messages using the individual contact information, the plurality of messages configured to partition information about the customer selection based at least in part on the order fulfillment responsibilities.
